(19) United States
(12) Patent Application Publication
(10) Pub. No.: US 2004/0130891 A1
(43) Pub. Date: Jul. 8, 2004

(54) Mobile lamp

(76) Inventor: Harald Twardawski, Rastatt (DE)

Correspondence Address: HARNESS, DICKEY & PIERCE, P.L.C., P.O. BOX 828, BLOOMFIELD HILLS, MI, 48303, US

(21) Appl. No.: 10/718,477

(22) Filed: Nov. 20, 2003

(30) Foreign Application Priority Data
Nov. 22, 2002 (DE) 102 54 634.7
Nov. 22, 2002 (DE) 102 54 630.4
Jun. 25, 2003 (DE) 103 28 576.8

(51) Int. Cl. F21L 2/00

(52) U.S. Cl. 362/157

(57) ABSTRACT

A mobile lamp includes a first lighting unit for the radiation of a first light beam in a first radiation direction which, for the formation of the first light beam, has at least one first light emitting diode element and one image producing device which is associated with the first light emitting diode element and to which light emitted by the first light emitting diode element can be supplied, and a second lighting unit for the radiation of a second light beam in a second radiation direction differing from the first radiation direction which, for the formation of the second light beam, has at least one second light emitting diode element and one image producing device which is associated with the second light emitting diode element and to which light emitted by the second light emitting diode element can be supplied.

### CROSS REFERENCE TO RELATED APPLICATIONS

This application claims priority to German Patent Application Nos. 102 54 634.7, filed Nov. 22, 2003, 102 54 630.4, filed Nov. 22, 2002, and 103 28 576.8, filed Jun. 25, 2003, which are hereby incorporated by reference herein.

### FIELD OF THE INVENTION

The present invention relates to a mobile lamp.

### BACKGROUND OF THE INVENTION

Mobile lamps are generally known. Lamps are in particular understood by this which are transportable and which can be operated during their use without a connection to a mains network. Examples for such mobile lamps are, for example, flashlights, head lamps or also lamps for vehicles.

For many applications, it is desirable to be able to change the illumination of a given area or of a given spatial region. With a conventional head lamp using a light bulb, for example, the light emitted by the light bulb can be focused for this purpose in that a reflector with focusing properties, displaceable relative to the light bulb and surrounding the light bulb, is used.

However, such mobile lamps have a series of disadvantages. On the one hand, light bulbs consume a great deal of power such that either a large and heavy power supply is required, for example by batteries, or corresponding lamps only have a short operating time. On the other hand, an adjustable focusing of the emitted light requires a comparatively complex guiding of the reflector.

### SUMMARY OF THE INVENTION

It is therefore the underlying object of the present invention to provide a mobile lamp of simple design whose radiation characteristics can be changed in order to illuminate a given area or a given spatial region.

The object is satisfied by a mobile lamp having the features of claim 1.

The mobile lamp in accordance with the invention includes a first lighting arrangement which has a first light emitting diode element and a first image producing device associated with it for the focusing or expanding of a first light beam presented by the first light emitting diode element or a plurality of first light emitting diode elements and first image producing devices respectively associated with them for the focusing or expanding of first light beams emitted by the first light emitting diode elements, and also includes a second lighting arrangement which has a second light emitting diode element and a second image producing device associated with it for the focusing or expanding of a second light bundle emitted by the second light emitting diode element or a plurality of second light emitting diode elements and second image producing device respectively associated with them for the focusing or expanding of second light beams each emitted by the second light emitting diode elements, with the second light beam or the second light beams being focused more than the first light beam or the first light beams and including a switching device by means of which the light emitting diode element or the light emitting diode elements of one of the lighting arrangements can be switched on and off separately from the light emitting diode element or the light emitting diode elements of the other lighting arrangement.

A mobile lamp is understood to be a lamp which is portable or movable and which does not require any connection to a fixedly installed mains network during operation.

The two lighting arrangements serve for the emission of light, for which purpose they each have at least one light emitting diode element and one image producing device associated with it. The light emitting diode elements can generally be any desired light emitting diodes, in particular also light emitting diodes with an integrated illuminated body, in particular made of glass, serving for the convergence of the light emitted by the convergence of the light emitting diode.

To be able to emit light beams with a suitable focusing, an image producing device is associated with each of the light emitting diode elements and serves for the focusing or expanding of a light beam emitted by the respective light emitting diode element. For this purpose, depending on the demand, they can produce real or virtual images of the light emitting diode elements. The image producing devices for different light emitting diode elements can be provided spatially separate from one another or by different sections of optical components onto which only one light beam of a light emitting diode element is incident in each case.

The light emitting diode elements and the corresponding image producing devices of the first and second lighting arrangements are designed such that, when only one second light emitting diode element is used, the second light beam is focused more and when a plurality of second light emitting diode elements are used, a plurality of second light beams are focused more after the image producing by the image producing device than the first light beam or the first light beams after passing through the first image producing device. This means that a cross-sectional area of the first light beam or of the first light beams is larger at a pre-determined distance from the lamp than a cross-sectional area of the second light beam or the second light beams at the pre-determined distance. With conical light beams, the opening angle of the second light beams is then smaller than that of the first light beams.

In this manner, differently tightly focused light beams can be emitted with the first and second lighting arrangements.

A switching device is provided for the switching on and off of the light emitting diode elements of the lighting arrangements by means of which the light emitting diode element or the light emitting diode elements of one of the light arrangements can be switched on and off separately from the light emitting diode element or the light emitting diode elements of the other lighting arrangement. This means that the two lighting arrangements can be switched off together and can be switched on and off at least alternatively. The switching on of both lighting arrangements is preferably additionally provided as a further operating mode.

In this manner, the bundling or focusing of the light which can be emitted by the mobile lamp can be changed very simply by switching between the two lighting arrangements. It is in particular possible to select a matched illumination in dependence on a given situation. A pre-determined spatial region or a pre-determined area can thus be illuminated particularly effectively depending on the requirements, while as little light as possible is guided into adjacent regions not to be illuminated. An adjustable focusing device is therefore not necessary so that the mobile lamp is not only simple to manufacture, but is also very robust in handling.

By the use of light emitting diode elements as lighting means, it is moreover possible, on the one hand to achieve a substantially larger light yield in comparison with light bulbs or halogen light bulbs with a pre-determined energy take-up such that, for example on operation with a battery or with a rechargeable battery, either a substantially larger luminous intensity or a substantially longer lighting time can be achieved. On the other hand, light emitting diode elements have substantially longer service lives and are less sensitive to shocks than light bulbs or halogen light bulbs.

The light emitting diode elements of the first or second lighting arrangements can generally be arranged as desired. It is, however, preferred for one of the two lighting arrangements to have at least three light emitting diode elements and image producing devices respectively associated with them and for the light emitting diode elements to be arranged such that they surround the light emitting diode element or the light emitting diode elements of the other lighting arrangement in a plane in which the light emitting diode elements of the one lighting arrangement are arranged. A particularly compact arrangement of the light emitting diode elements thus results in which in particular the radiation directions of the light beams emitted by the two lighting arrangements can extend in substantially the same directions such that a user does not perceive any jumping of the total light beam formed by the light beams of the light emitting diode elements when switching the focusing, i.e. between the two lighting arrangements. The light emitting diode elements of the second lighting arrangement preferably surround the light emitting diode elements of the first lighting arrangement.

In order to allow a particularly uniform illumination, on the one hand, and a particularly compact arrangement, on the other hand, it is preferred for the light emitting diode elements of the one lighting arrangement, which surround the light emitting diode element or the light emitting diode elements of the other lighting arrangement, to be arranged substantially along a circle or along an ellipse. Two successive light emitting diode elements each particularly preferably have the same spatial or angular intervals from one another. When arranged along a circle and at equal angular intervals, the light emitting diode elements can then be arranged at the corner points of regular polygons, for example of equilateral triangles, squares, equilateral pentagons or equilateral hexagons.

In order to achieve a particularly simple production, on the one hand, and an illumination which is as uniform as possible, on the other hand, it is preferred for the light emitting diode elements and the image producing devices of at least one of the lighting arrangements associated with them to be designed such that the light beams emitted by the lighting arrangement are substantially focused equally tightly. The light emitting diode elements and the associated image producing devices of both lighting arrangements are preferably made such that their light beams are each substantially focused equally tightly. A more uniform illumination is achieved in this manner with all operating modes.

The image producing devices can generally be made as desired. They can in particular be provided by part sections of optical components which are only irradiated by one light beam. Reflectors, for example appropriate parabolic mirrors, can generally also be used. It is, however, preferred for at least one image producing device of the first and/or second light arrangements to include a lens which is preferably arranged spaced apart from the respective light emitting diode element. All image producing devices of the first and/or second lighting arrangements are particularly preferably formed by a lens. Such arrangements are particularly easy to manufacture, in particular plastic lenses can be used with this process. Moreover, lenses only take up very little space so that a correspondingly compact lamp results. The magnitude of the expansion or of the focusing of the light beams can be influenced by the selection of the spacing between the light emitting diode elements and the lenses and/or preferably by the selection of the shape and/or the focal lengths of the lenses.

With respect to the manufacture and also to the alignment of the image producing device toward the corresponding light emitting diode elements, it is preferred for the image producing devices of the two lighting arrangements to be made in one piece in one component. Lenses in a plate which is manufactured by injection molding from a highly transparent plastic and which is then applied as whole in front of the lighting arrangement can in particular be formed as image producing devices

The light beams of the light emitting diode elements of the lighting arrangements each form total light beams of the corresponding lighting arrangements with which a total radiation direction can be associated by an appropriate averaging over the directions of the light rays emitted in total by the respective lighting arrangement. These total radiation directions can generally be aligned in any desired manner to one another. It is, however, preferred for the first and the second lighting arrangements each to have the same total radiation directions. In this manner, a jumping of the light ray between different spatial regions is avoided on a switching between the two lighting arrangements. Moreover, on a common switching on of the two lighting arrangements, the emitted total light beams can overlap and so be used for a particularly strong illumination of a pre-determined area.

The light emitting diode elements each emit a light beam with which a main radiation direction can be associated by averaging over the light rays contained therein. These main radiation directions can generally be aligned in any desired manner, for example parallel, for light emitting diode elements of one of the lighting arrangements. However, to enable a large luminous intensity at pre-determined distances from the lamp, it is preferred for the main radiation directions of the light emitting diode elements and/or for the optical axes of the image producing devices of the first and/or of the second lighting arrangements to extend inclined at first and/or second acute inclination angles to a total radiation direction of the respective lighting arrangement. Due to the simpler manufacture and adjustment, it is particularly preferred for the optical axes of the image producing devices to extend inclined to the respective total radiation direction. The light beams can then overlap at a distance from the lamp determined by the inclination angle and allow a particularly strong illumination there.

In particular with a substantially circular arrangement of the light emitting diode elements, it is particularly preferred for the inclination angle to be of the same size within at least one of the lighting arrangements. The optical axes of the image producing devices then intersect substantially at one point such that the light beams emitted by the corresponding light emitting diode elements can intersect or overlap at a plane including this point and substantially orthogonal to the total radiation direction and thus permit a particularly large luminous intensity in the overlapping region.

It is preferred in an embodiment for the second inclination angles to be smaller than the first inclination angles. In particular when the light emitting diode elements of the second lighting arrangement surround the light emitting diode elements of the first lighting arrangement, a substantially complete overlapping of the cross-sections of the light beams of the second lighting arrangement results at a distance which is larger than the distance at which the cross-sections of the light beams of the first light arrangement overlap. The more tightly focused light of the second lighting arrangement can therefore be used as the main beam, while the light beams of the first lighting unit represent a favorable illumination for the near region.

It is further preferred for the first and second light beams to overlap at a pre-determined distance from the lighting arrangements at least partly inside a circle with a diameter of 0.5 m to 2 m, preferably of 1 m. The pre-determined distance preferably lies between 0.5 m and 3 m. From this range, the user then perceives a coherent light spot which is formed by the first or second light beams and which is inclined toward the coherent illumination of an area.

To permit an illumination which is as pleasant as possible for an observer and in particular also to facilitate the recognition of colors, it is preferred for the light emitting diode elements of at least one light arrangement to be made for the emission of substantially white light. Preferably all light emitting diode elements used are suitable for the emission of substantially white light.

It is furthermore preferred, when lenses are used as image producing devices, for tubes to be arranged between the lenses and the light emitting diode elements through which in each case light of a light emitting diode elements can be guided to the corresponding lens, but which prevent a dispersion of light of a light emitting diode element into the region of a lens which is associated with another light emitting diode element. A particularly sharply delineated light beam is achieved in this manner. If as little light as possible should be lost, it is particularly preferred for the tubes to have an internal surface which is highly reflective for light of the light emitting diode elements. Alternatively, a reflector can be provided for each light emitting diode element which opens in the radiation direction of the light emitting diode element and by means of which light emitted by the light emitting diode element can be focused. Such a reflector can in particular be used in addition to a lens. To achieve a particularly sharp delineation of the light beam, it is, in contrast, particularly preferred for the tubes to have a surface which is only slightly reflective, or not at all reflective, for light of the light emitting diode elements and which can in particular be black and/or matt.

The mobile lamp in accordance with the invention can be made for the most varied uses. In a preferred further development, provision is made for the lamp to be made as a vehicle lamp, in particular as a bicycle lamp. It can in particular be used as a front lamp on a bicycle, with the first lighting arrangement being able to be used for the making available of the main beam, which is incident to the road at a distance of approximately 8 to 10 m in front of the lamp at a tight focus, and the second lighting unit being able to be used for the making available of parking light which is radiated with an opening angle which is large as possible. The lamp in accordance with the invention can have appropriate fastening means for the fastening of the lamp to a bicycle.

In another preferred further development, provision is made for the lamp to be made as a hand lamp or as a flashlight. It can in particular have an appropriate grip for this purpose. A mobile lamp made in this manner permits the user to achieve a good illumination of a region to be observed in a simple manner in very different situations.

In another preferred further development, provision is made for the lamp to be made as a head lamp. It is then particularly suitable as an illumination in the dark when a user alternatively requires light in the region of the hands or light at a distance, such as is the case when camping. It can in particular have an elastic headband for this purpose by means of which it can be fastened to a head of a user.

The lamp in accordance with the invention can be supplied with power in a variety of manners. It is in particular preferred with a design as a hand lamp or as a flashlight or as a head lamp for the lighting arrangements to be arranged in a housing in which a battery compartment is provided. A simple, compact lamp results which is easy to transport.

In accordance with another preferred further development, in particular with a design as a head lamp, it is preferred for the lighting units to be held at an elastic band in a housing and for a battery holder to be held at the band. Batteries or rechargeable batteries can be placed into said battery holder which serve for the feeding of the light emitting diode elements in the lighting arrangements. The housing with the lighting arrangements can thereby be kept particularly small and light such that only comparatively small inertia forces act even on fast movements and the housing with the lighting units can thus be pivoted quickly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a lateral sectional view through a mobile lamp in accordance with a preferred embodiment of the invention in the form of a flashlight;

FIG. 2 is a plan view of a head part of the mobile lamp in FIG. 1;

FIG. 3 is a schematic, partial sectional view through the head part in FIGS. 1 and 2 together with a schematic representation of light beams emitted by first and second light arrangements of the mobile lamp in FIG. 1;

FIG. 4 is a representation in FIG. 3, with, however, only light beams of the first lighting arrangement being shown; and

FIG. 5 is a representation in FIG. 3, with now, however, only the light beams of the second lighting arrangement being shown.

### DETAILED DESCRIPTION OF THE PREFERRED EMBODIMENTS

The following description of the preferred embodiment(s) is merely exemplary in nature and is in no way intended to limit the invention, its application, or uses.

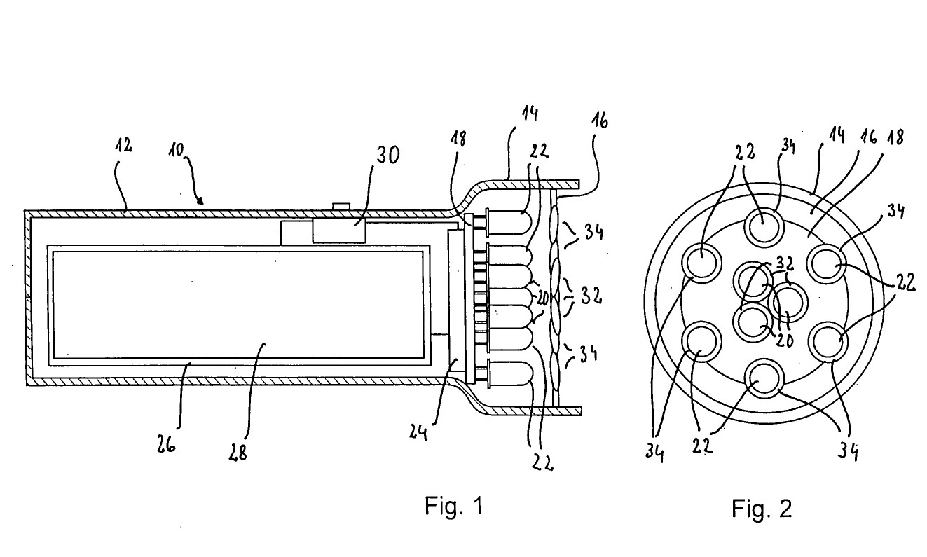

In FIG. 1, a flashlight in a housing 10 with a grip part 12 and a head part 14 behind a front plate 16 on a carrier 18 includes first and second light emitting diode elements 20 and 22, a supply switch 24 for the supply of the first and second light emitting diode elements 20 and 22 with power. A battery 28 is arranged in a battery compartment 26 in the grip part 12 for the supply of the supply circuit 24. Contact elements in the battery compartment 26 are connected directly to the supply circuit 24, on the one hand, and via a push button 30 held in the grip part 12, on the other hand.

The light emitting diode elements 20 and 22 are white light emitting diodes with a glass element which serves to converge light emitted by the diode.

As shown in FIG. 2, three first light emitting diode elements 20 are arranged at the corners of an equilateral triangle centered with respect to the center of the carrier 18. Six second light emitting diodes 22 are arranged about this arrangement of first light emitting diodes 20 at a circle at equal angular intervals from one another or at the corners of a regular hexagon such that they surround the group of first light emitting diodes 20 in a circular manner.

The light emitting diodes 20 and 22 are aligned with their main radiation direction, which results by averaging over all the light rays emitted by them, parallel to one another and parallel to a normal on the surface of the carrier through its center.

The light emitting diodes 20 and 22 are connected to the supply circuit 24 via conducting tracks on the carrier 18 formed as a board. The supply circuit 24 is made such that the first light emitting diodes 20 or the second light emitting diodes 22 can each be switched on and off together as parts of a first or second lighting arrangement respectively. The push button 30 serves in conjunction with the supply circuit 24 for the switching on and off. By repeated pressing of the push button, the light emitting diodes can be put into four different states. In a first state, only the first light emitting diodes 20, i.e. the first lighting arrangement 20, are switched on, while the second light emitting diodes 22 are switched off; in a second state, only the second light emitting diodes 22 are switched on and in a third state, all light emitting diodes are switched on. Finally, in a fourth state, all light emitting diodes are switched off. The supply circuit 24 therefore forms, together with the push button 30, a switching device for switching on and off of the light emitting diodes in the sense of the invention.

First lenses 32 as first image producing devices associated in each case with the first light emitting diode elements 20 and second lenses 34 as second image producing devices associated in each case with the second light emitting diodes 22 are formed in the front plate 16 and are each aligned on the first or second light emitting diode elements 20 or 22 respectively. The front plate 16 is made as an injection molded part from a highly transparent plastic, for example from polycarbonate.

The first and second lenses 32 and 34 are each aligned to corresponding first and second light emitting diode elements 20 and 22 such that the first lenses 32 and the first light emitting diode elements 20 form a first lighting arrangement and the second lenses 34 and the second light emitting diode elements 22 form a second lighting arrangement.

For this purpose, the front plate 16, like the carrier 18, is also held by appropriate positioning means in the head part 14 with the first and second lenses 32 and 34 respectively aligned to the corresponding first or second light emitting diode elements 20 and 22 respectively.

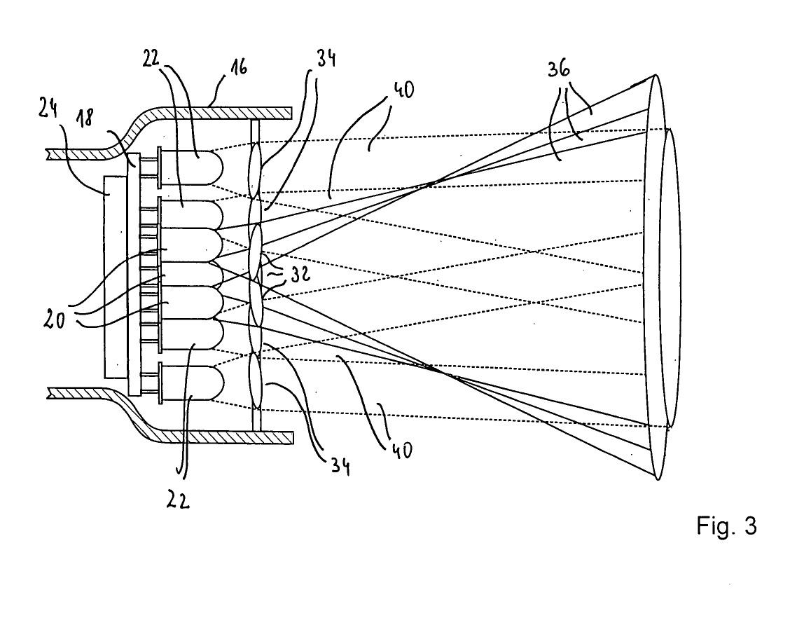

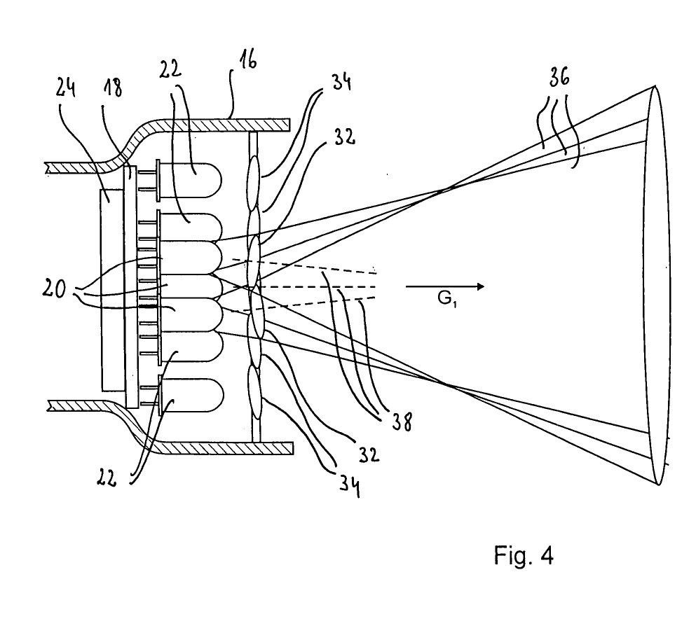

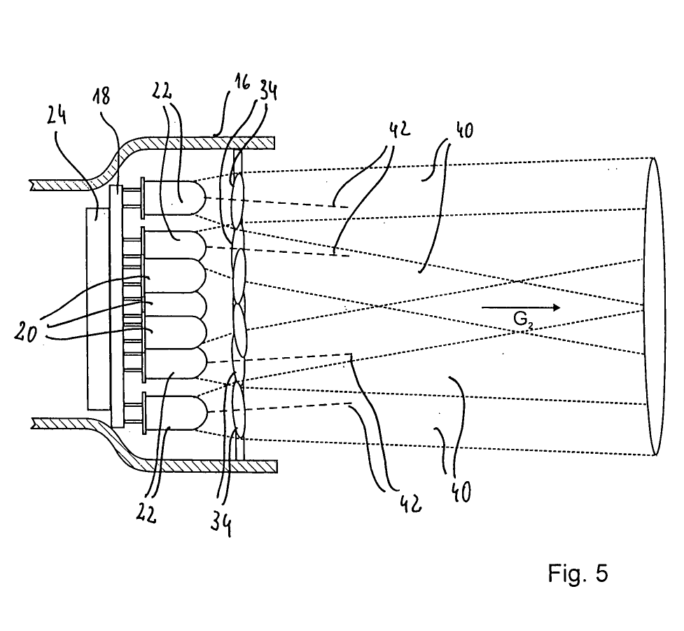

The focal length of the first lenses of the same design and their positions with respect to the respective first light emitting diode elements 20 are selected such that the first lenses 32 expand the first light beams 36 emitted by the first light emitting diode elements 20 (cf. FIGS. 3 and 4).

The optical axes 38 of the first image producing devices or lenses 32 are inclined at an acute first inclination angle with respect to a normal on the carrier 18 leading through the center of the carrier 18 such that the optical axes 38 substantially intersect at a point on the normal, on the one hand, and the first light beams 36 expanded by the first lenses 32 overlap completely at a distance of approximately 1 m. At this distance, an approximately circular area having a diameter of approximately 1 m is illuminated. This is shown only very schematically in FIGS. 3 and 4 and not to scale.

On an averaging over the directions of all light rays of the first light beams 36, a total radiation direction G₁ of the first light arrangement formed by the first light emitting diode elements 20 and by the first lenses 32 results which extends coaxially with the normal through the center of the carrier 18.

The lenses 34 associated with the second light emitting diode elements 22 form a second lighting arrangement with them.

The focal length of the second lenses 34 designed the same and their positions to the respective second light emitting diode elements 22 are selected such that the second light beams 40 of the second light emitting diode elements 22 are not expanded by the second lens elements 34, but are somewhat focused (cf. FIGS. 3 and 5).

The optical axes 42 of the second imaging devices or of the second lenses 34 are inclined at an acute second inclination angle to the normal on the carrier 18 through its center such that they intersect at a point on the normal. Since the second inclination angles are smaller than the first inclination angles, the point of intersection of the optical axes 42 of the second lenses 34 are further away from the front plate 16 than the corresponding point of intersection of the optical axis 38 of the first lenses 32. The second light beams 40 focused by the second lenses 34 therefore overlap completely at a distance of approximately 8 m such that an approximately circular area with a diameter of approximately 2 m is illuminated at this distance. This is shown only very schematically and not to scale in FIGS. 3 and 5.

The total radiation direction G₂ of the second lighting arrangement, which results as with the first lighting arrangement by averaging over the direction of the light rays of the second light beams 40 in the beam path behind the second lenses 34, therefore extends coaxially with the total radiation direction G₁ of the first lighting arrangement and thus of the normal on the carrier 18 through its center.

The first and second light beams 36 and 34 respectively overlap at a distance 2 m from the lighting arrangements at least partly inside a circuit with a diameter of 1.5 m.

A user of the flashlight can now produce differently focused light by actuating the push button 30. In the first state, only the first light emitting diode elements 20 of the first lighting arrangement are switched on such tat a very divergent total light bundle resulting from the first light beams 38 results which produces a sharply delineated approximately circular light spot in a near region (cf. FIG. 4).

In the second state, only the second light emitting diode elements 22 are switched on which now radiate more tightly focused second light beams 40 which only overlap at a larger distance to form an approximately circular light spot and are therefore suitable as a main beam.

In the third state, all light emitting diode elements are switched on such that both a widely spread light beam is radiated for the near region and a more tightly focused light beam is radiated simultaneously for the distance region. Since, in this embodiment, the number of the second light emitting diode elements 22 for the illumination of the distance region is larger than the number of the first light emitting diode elements 20 for the illumination of a near region, an only slight weakening of the luminous intensity of the emitted total light beam, i.e. of the corresponding intensity, also results in the distance region.

In another preferred embodiment of the invention, the acute first and second inclination angles of the lenses 32 or 34 are selected equally large such that the corresponding first and second light beams overlap at the approximately same distance of 1 m from the front plate 16 in a substantially circular shape in a circle with approximately 1 m diameter such that, on the common operation of all light emitting diode elements, a particularly large luminous intensity can be achieved at this distance inside the circle.

In a still further embodiment, the first and second light emitting diode elements 20 and 22 respectively are each held in tubes with an interior matt surface which extend from the carrier 18 up to the lenses associated with the respective light emitting diode elements and so prevent a penetration of scattered light of adjacent light emitting diode elements into the lens associated with a light emitting diode.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mobile lamp comprising:
a first lighting arrangement which has a first light emitting diode element (20) and a first image producing device (32) associated with it for the focusing or expanding of a first light beam (36) emitted by the first light emitting diode element (20) or has a plurality of first light emitting diode elements (20) and first image producing devices (32) respectively associated with them for the focusing or expanding of first light beams (36) emitted by the first light emitting diode elements (20);
a second lighting arrangement which has a second light emitting diode element (22) and a second image producing device (34) associated with it to change the focusing or expanding of a second light beam (40) emitted by the second light emitting diode element (22) or has a plurality of second light emitting diode elements (22) and second image producing devices (34) respectively associated with them for the focusing or expanding of second light beams (40) emitted in each case by the second light emitting diode elements (40), with the second light beam (40) or the second light beams (40) being focused more tightly than the first light beam (36) or the first light beams (36); and
a switching device (24, 30) by means of which the light emitting diode element (20, 22) or the light emitting diode elements (20, 22) of one of the lighting arrangements can be switched on and off separately from the light emitting diode element (20, 22) or the light emitting diode element (20, 22) of the other lighting arrangement.

2. A mobile lamp in accordance with claim 1, characterized in that one of the two lighting arrangements has at least three light emitting diode elements (22) and image producing devices (34) associated with them; and in that the light emitting diode elements (22) are arranged such that they surround the light emitting diode element (20) or the light emitting diode elements (20) of the other lighting arrangement in a plane in which the light emitting diode elements (22) of the one lighting arrangement are arranged.

3. A mobile lamp in accordance with claim 2, characterized in that the light emitting diode elements (22) of the one lighting arrangement, which surround the light emitting diode element (20) or the light emitting diode elements (20) of the other lighting arrangement, are arranged substantially along a circle or along an ellipse.

4. A mobile lamp in accordance with claim 1, characterized in that the light emitting diode elements (20, 22) and the image producing devices (32, 34) of at least one of the lighting arrangements associated with them are made such that the light beams (36, 40) emitted by the lighting arrangement are substantially focused equally tightly.

5. A mobile lamp in accordance with claim 1, characterized in that at least one image producing device of the first and/or second lighting arrangements includes a lens (32, 34) which is preferably arranged spaced apart from the respective light emitting diode element (20, 22)

6. A mobile lamp in accordance with claim 1, characterized in that the image producing devices (32, 34) of the two lighting arrangements are made in one piece in one component (16).

7. A mobile lamp in accordance with claim 1, characterized in that the first and the second lighting arrangements each have the same total radiation directions (G₁, G₂).

8. A mobile lamp in accordance with claim 1, characterized in that the main radiation directions of the light emitting diode elements (20, 22) and/or the optical axes (38, 42) of the image producing devices (32, 34) of the first and/or second lighting arrangements extend inclined at first and/or second acute inclination angles to a total radiation direction (G₁, G₂) of the respective lighting arrangement.

9. A mobile lamp in accordance with claim 8, characterized in that the inclination angles inside at least one of the lighting arrangements are of equal size.

10. A mobile lamp in accordance with claim 8, characterized in that the second inclination angles are smaller than the first inclination angles.

11. A mobile lamp in accordance with claim 1, characterized in that the first and second light beams (36, 40) overlap at a pre-determined distance from the lighting arrangements at least partly within a circle with a diameter from 0.5 m to 2 m, preferably of approximately 1 m.

12. A mobile lamp in accordance with claim 1, characterized in that, the light emitting diode elements (20, 22) are made for the emission of substantially white light.

13. A mobile lamp in accordance with claim 1, characterized in that the lamp is formed as a vehicle lamp, in particular as a bicycle lamp.

14. A mobile lamp in accordance with claim 1, characterized in that the lamp is made as a hand lamp or as a flashlight.

15. A mobile lamp in accordance with claim 1, characterized in that the lamp is made as a head lamp.
